(19) United States
(12) Patent Application Publication
(10) Pub. No.: US 2015/0265949 A1
(43) Pub. Date: Sep. 24, 2015

(54) FLUID FILTER

(71) Applicant: Caterpillar Inc., Peoria, IL (US)

(72) Inventors: Bryant A. Morris, Peoria, IL (US); Jeffrey R. Ries, Metamora, IL (US)

(73) Assignee: Caterpillar Inc., Peoria, IL (US)

(21) Appl. No.: 14/217,915

(22) Filed: Mar. 18, 2014

(51) Int. Cl. B01D 29/54

(52) U.S. Cl. CPC B01D 29/54

(57) ABSTRACT

A filter element, assembly and method of filtering is disclosed. The filter element may comprise an outer filter having a top and a bottom, and an inner filter. The outer filter may define an interior space and a longitudinal axis. The interior space may extend from the top to the bottom of the outer filter along the longitudinal axis. The inner filter may be disposed inside the interior space. The inner filter may be offset along the longitudinal axis from the bottom of the outer filter. The offset may define a cavity disposed below the inner filter and adjacent to the bottom of the outer filter. The outer filter may be configured to guide fluid in a first direction and the inner filter may be configured to guide fluid in a second direction generally parallel to the longitudinal axis, the second direction different from the first direction.

### TECHNICAL FIELD

The present disclosure relates to filters and, more particularly, to fluid filter systems.

### BACKGROUND

Cartridge style fluid filters, such as, for example, fuel or lubricant filters associated with an engine, typically include a replaceable filter element contained within a container that is threadingly engaged to a base and the base is mounted to the engine or to the machine. Fluid to be filtered, e.g., fuel or lubricant, is received by the filter via an inlet port, particulates are removed from the fluid via the filter element, and filtered fluid is delivered to the engine via an outlet port. The filter element often includes a generally cylindrical filter medium, e.g., fabric or other porous material, supported within the container via one or more endcaps, such that fluid flows through the filter medium in a generally radial direction. An endcap typically supports and/or positions the filter medium within the container and with respect to the inlet and outlet ports. Fluid filters usually also include one or more seals that sealingly separate the inlet and outlet ports to reduce or eliminate fluid from bypassing the filter medium.

U.S. Pat. No. 3,468,425 (“the '425 patent”) issued to Engstrom discloses a fluid filter element of the cylindrical radial flow type. The filter comprises a hollow cylinder formed of fibrous filter media in web form that is coiled upon itself. Certain of the outer convolutions of the filter media are axially longer at the top of the filter element than other inner convolutions. In order to provide two stage filtration, the entire filter element is impregnated with resin which is cured—providing rigidity both radially and longitudinally. In one embodiment, the axially longer convolutions are formed from one coil of filter media and the other convolutions are formed from a separate coil of media. The filter of the '140 patent provides two stage filtration for fluids flowing in the radial direction. In operation, the oil flows inwardly through the outer and inner convolutions until dirt loading increases the flow resistance to a point where the majority of the flow is through the portion of the outer convolutions that extend above the inner convolutions. Once dirt loading produces a pressure differential that causes a bypass valve to open, the filter element has reached the end of its life. While beneficial, a better filter is desired that more efficiently filters fluids.

### SUMMARY OF THE DISCLOSURE

In one aspect, the present disclosure is directed to a filter element. The filter element may comprise an outer filter having a top and a bottom, and an inner filter. The outer filter may define an interior space and a longitudinal axis. The interior space may extend from the top to the bottom of the outer filter along the longitudinal axis. The inner filter may be disposed inside the interior space. The inner filter may be offset along the longitudinal axis from the bottom of the outer filter. The offset may define a cavity disposed below the inner filter and adjacent to the bottom of the outer filter. The outer filter may be configured to filter and guide fluid in a first direction and the inner filter may be configured to filter and guide fluid in a second direction generally parallel to the longitudinal axis. The second direction is different from the first direction.

In one embodiment, the inner filter may be rolled. In another embodiment, the inner filter may be corrugated media and the outer filter may be cellulose media. In another embodiment, the inner and outer filters may be generally oval-shaped.

In an embodiment, the filter element may further comprise a center tube and a ring. The center tube may be disposed between the inner filter and the outer filter. The center tube may be shaped and positioned to define a gap between the inner filter and the outer filter. The ring may be disposed inside the center tube and above the inner filter.

In an embodiment, the outer filter may be configured to filter and guide received fluid in a travel path generally parallel to the longitudinal axis.

In an embodiment, the filter element may further comprise a first layer disposed between the inner filter and the outer filter. The first layer may extend substantially the full longitudinal length of the inner filter and be impervious to fluid.

In another aspect, the present disclosure is directed to a filter assembly. The filter assembly may include a container defining a longitudinal axis, a removeable filter element, and a base. The container is configured to be received by the base. The filter element may comprise an outer filter disposed inside the container, and an inner filter. The outer filter having a top and a bottom and defining an interior space that extends from the top to the bottom of the outer filter. The inner filter is disposed inside the interior space and may be offset along the longitudinal axis from the bottom of the outer filter. The offset may define a cavity disposed below the inner filter and adjacent to the bottom of the outer filter. The base is disposed adjacent to the top of the outer filter, and may including an inlet and a nozzle having an outlet. The inlet fluidly connected to the top of the outer filter, and the outlet fluidly connected to the inner filter. The filter assembly is configured to filter and guide liquid in a generally downward direction from the inlet to the cavity, and the inner filter is configured to filter and guide liquid, in an upward direction generally parallel to the longitudinal axis, to the outlet of the nozzle.

In an embodiment, the inner filter may be rolled corrugated media and the outer filter may be cellulose media. In a refinement, the inner filter may be generally oval-shaped, and the outer filter may be generally oval-shaped cellulose media.

In an embodiment, the filter element may further include a center tube and a first seal. The center tube may be disposed between the inner filter and the outer filter. The center tube may be shaped and positioned to define a gap between the outer filter and the inner filter. The first seal may be disposed inside the center tube and between the outer filter and the nozzle. The first seal may be configured to establish a radially facing seal interface with the nozzle. In a refinement, the filter element may further include an inner ring disposed inside the center tube, above the inner filter, and below the first seal. In a further refinement, the center tube may be a spiral center tube.

In another embodiment, the filter element may further include a first seal and a second seal. The first seal may be disposed between the outer filter and the nozzle, and may be configured to establish a radially facing seal interface with the inner filter. The second seal may be disposed between the outer filter and the base and between the outer filter and the container.

In an embodiment, the filter element may further include spiral roving disposed around the outer filter between the outer filter and the container. The outer filter in such embodiment may be made of cellulose media.

In another embodiment, the inner and outer filters may be made of rolled corrugated media, and the outer filter may be configured to filter and guide received fluid in a generally downward travel path generally parallel to the longitudinal axis. In a refinement, the filter assembly may further include a vented center tube generally parallel to the longitudinal axis. The inner filter may surround the vented center tube.

In another embodiment, the filter element may further include a first layer disposed between the inner filter and the outer filter, where the inner filter may be rolled and the first layer may be impervious to liquid fluid.

In another embodiment, the filter element may further comprise a first radial seal disposed around the inner filter and above the top of the outer filter. The inner filter may be disposed partially in the outlet port and may be stepped above the top of the outer filter.

In an embodiment a method is disclosed of filtering a liquid fluid in a vehicle system with a filter assembly. The filter assembly may include a container, a filter element and a base. The container may define a longitudinal axis, and may be configured to be received by the base. The filter element may include an outer filter disposed inside the container, and an inner filter. The outer filter has a top and a bottom. The outer filter may define an interior space extending from the top to the bottom of the outer filter. The inner filter may be disposed inside the interior space. The inner filter may be offset along the longitudinal axis from the bottom of the outer filter, and the offset may define a cavity disposed below the inner filter and adjacent to the bottom of the outer filter. The base may be adjacent to the top of the outer filter. The base may include an inlet and a nozzle having an outlet. The inlet may be fluidly connected to the top of the outer filter, and the outlet may be fluidly connected to the inner filter. The method may comprise receiving fluid from an inlet in the base, filtering fluid as it flows in a first direction from the inlet port through the outer filter into the cavity, and filtering fluid from the cavity as it flows second direction to the outlet port of the nozzle through the inner filter from the cavity, the second direction different from the first direction, the second direction generally parallel to the longitudinal axis.

### BRIEF DESCRIPTION OF THE DRAWINGS

FIG. 1 is a cross-sectional illustration of an exemplary fluid filter assembly in accordance with the present disclosure;

FIG. 2 is a diagrammatic illustration of an exemplary filter element of the filter assembly of FIG. 1;

FIG. 3 is a cross-sectional view of another embodiment of filter element shown without the roving;

FIG. 4 is a perspective view of an embodiment of the center tube of FIG. 3.

FIG. 5 is a cross-sectional illustration of another exemplary fluid filter assembly in accordance with the present disclosure;

FIG. 6 is a diagrammatic illustration of an exemplary filter element of the filter assembly of FIG. 5;

FIG. 7 is an enlarged cut-away view of a portion of the filter assembly of FIG. 5; and

FIG. 8 is a flow chart depicting a sample sequence of steps which may be practiced in accordance with an exemplary method employing the teachings of the present disclosure.

### DETAILED DESCRIPTION

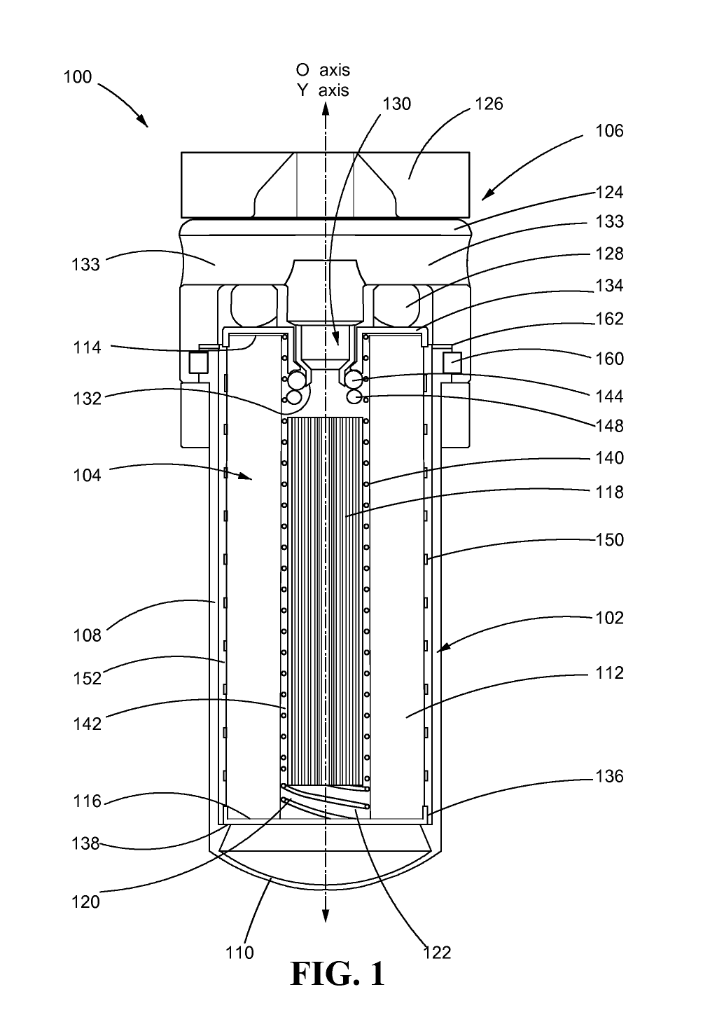

FIG. 1 illustrates a cross-section of an exemplary embodiment of a filter assembly 100. The filter assembly 100 may comprise a container 102, a filter element 104 disposed inside the container 102 and a base 106. The filter assembly 100 may be one of several components within a fluid system (not shown) and may be configured to receive fluid (for example, liquid fluid) from one or more upstream components of the fluid system, trap particles suspended within the fluid, i.e., filter the fluid, and provide filtered fluid to one or more downstream components of the fluid system. The fluid system may include any type of fluid system, e.g., a fuel delivery system, a lubricating system, and/or a coolant system, and may or may not be operatively associated with an engine (not shown). Additionally, filter assembly 100 may be configured to filter any type of fluid, such as, for example, gasoline, diesel fuel, lubricating oil, water, coolant, and/or the like. It is contemplated that the fluid of the fluid system may or may not be pressurized and, if so, may be at any pressure.

Container 102 may define a longitudinal axis Y. The container 102 may include an outer wall 108 and an endwall 110. The container 102 may be configured to be received by and coupled to the base 106. Outer wall 108 and endwall 110 may generally define an internal chamber configured to contain filter element 104. The outer wall 108 may be substantially cylindrical in shape. In another embodiment, the outer wall 108 may be substantially oval in shape. Other shapes are contemplated as well for the outer wall 108. In some embodiments, a coupler 160 and housing seal may be disposed on the container 102 to facilitate the sealed coupling of the base 106 and the container 102.

Filter element 104 may include an outer filter 112 having a top 114 and a bottom 116, and an inner filter 118. The outer filter 112 defines an interior space 120 extending from the top 114 to the bottom 116 of the outer filter 112. The outer filter 112 also defines a longitudinal axis O that is parallel with the container axis Y.

In one embodiment, such as that illustrated in FIGS. 1-3, the outer filter 112 may be made of cellulose media. In an embodiment, the outer filter may be pleated. In other embodiments, the outer filter 112 may be made of media other than cellulose media, for example corrugated media, and may be pleated, rolled or otherwise.

The inner filter 118 is disposed inside the interior space 120. The inner filter 118 may be offset along the longitudinal axis Y, O from the bottom 116 of the outer filter 112. The offset of the inner filter 118 defines a cavity 122 disposed below the inner filter 118 and adjacent to the bottom 116 of the outer filter 112. The inventors have found that the positioning of the cavity 122 relative to the filters 112, 118 and the flow of fluid in the filter assembly facilitates efficient flow of the fluid from the outer filter 112 to the inner filter 112 and helps reduce fluid blockage and pressure build-up within the filter assembly 100. In some embodiments, such as the one illustrated in FIG. 1, the inner filter may also be offset along the longitudinal axis Y,O from the top 114 of the outer filter 112.

In one embodiment, such as that illustrated in FIGS. 1-3, the inner filter 118 may be made of corrugated media. In an embodiment, the inner filter 118 may be rolled. In other embodiments, the inner filter 118 may be made of media other than corrugated media, for example cellulose media, and may be rolled, pleated, or otherwise.

The base 106 may be adjacent to the top 114 of the outer filter 112. The base 106 may include an outer wall 124 and a mounting portion 126. Mounting portion 126 may be configured to connect the filter assembly 100 to, for example, an engine, via one or more bolt holes (not shown). The base 12 may include an inlet 128, a nozzle 130 having an outlet 132, and an outbound artery 133. The inlet 128 is fluidly connected to the top 114 of the outer filter 112. The inlet 128 may be configured to receive fluid from one or more upstream components of the fluid system and may be configured to direct the fluid to the outer filter 112 of the filter element 104. In an embodiment, the inlet 128 may include a generally annular space within base 106 and with respect to longitudinal axis Y. The nozzle 130 and its outlet 132 may be configured to receive filtered fluid from the inner filter 118. The base 106 may be configured to direct the filtered fluid received by the nozzle 130 via its outlet 132 toward one or more downstream components of the fluid system through the outbound artery 133. The nozzle 130 may include a generally cylindrical space with respect to longitudinal axis Y and may be disposed radially within inlet 128. In some embodiments, the nozzle 130 may be generally funnel-shaped. In other embodiments, the nozzle utilizes other shapes.

In general, the filter assembly 100 is configured to filter (to trap particulates and/or other particles suspended within a fluid) and to guide received fluid from the inlet 128 to the cavity 122 (as discussed later). The inner filter 118 is configured to filter (to trap particulates and/or other particles suspended within a fluid) and to guide the fluid, in an upward direction generally parallel to the longitudinal axis Y, O, to the outlet 132 of the nozzle 130.

More specifically, the outer filter 112 is configured to filter and guide fluid in a first direction and the inner filter 118 is configured to filter and guide fluid in a second direction generally parallel to the longitudinal axis O, the second direction different from the first direction.

In an embodiment, the filter element 104 may include a center tube 140. In some embodiments, the filter element 104 may also include a top end cap 134 and a bottom end cap 136. In some embodiments, the filter element 104 may also include an inner seal 144, a ring 148 and roving 150.

The top end cap 134 may be disposed adjacent to base 106 and may be configured to support filter element 104 within, and with respect to, container 102 and to provide seals between base 106 and portions of the outer filter 112 and between inlet 128 and outlet 132, respectively.

The bottom end cap 136 may be disposed adjacent end wall 110 of container 102 and may be configured to support filter element 104 within, and with respect to, container 102. It is contemplated that bottom endcap 136 may engage an interior surface or lip 138 of outer wall 108 of container 102.

The center tube 140 may be disposed between the inner filter 118 and the outer filter 112. The center tube 140 may be shaped and positioned to define a gap 142 between the outer filter 112 and the inner filter 118. In one embodiment, the center tube 140 may be a spiral or spring-shaped center tube. In other embodiments, the center tube may be shaped otherwise. In some embodiments, for example the embodiment shown in FIG. 1, the nozzle 130 may extend into the center tube 140 and the top end cap 134 may be disposed between the nozzle 130 and the center tube 140.

In some embodiments, an inner seal 144 may be disposed inside the center tube 140 and between the outer filter 112 and the nozzle 130 proximal to the outlet 132. The inner seal 144 may be configured to establish a radially facing seal interface with the outer surface of the nozzle 130. In one embodiment, the inner seal may be an o-ring seal.

In embodiments that include the ring 148, the ring 148 may be disposed inside the center tube 140. In one such embodiment, the ring 148 may be disposed above the inner filter and below the inner seal 144. The ring 148 may be configured to support and seal against the inner seal 144.

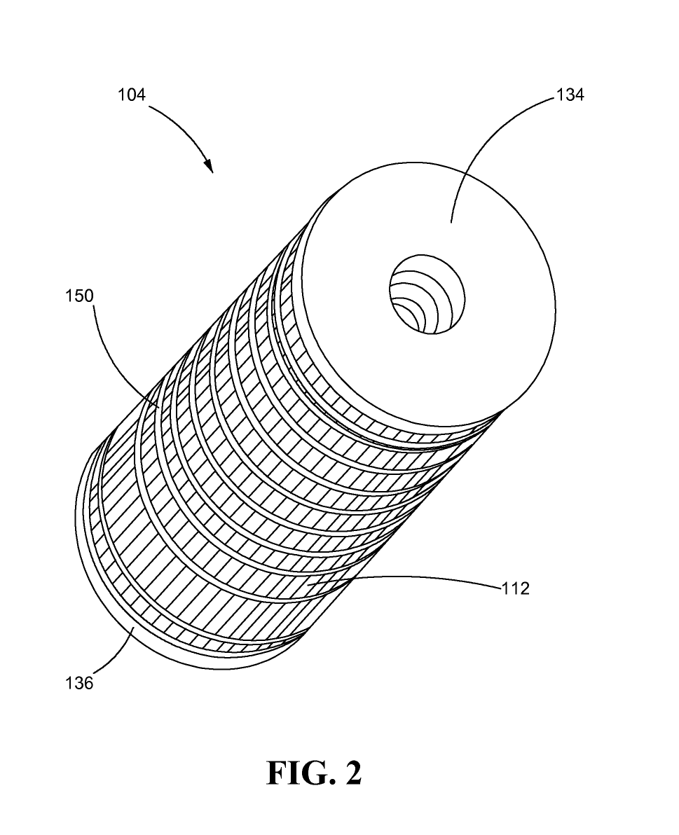

FIG. 2 illustrates a perspective view of one embodiment of the filter element 104 that includes a top end cap 134, a bottom end cap 136 and roving 150. The roving 150 may be spiral and may be disposed around the outer filter 112. As can be seen in the embodiment of FIG. 1, the roving 150 is disposed between the outer filter 112 and the container 102 when the filter element is positioned in the container 102. The position of the roving 150 may create a channel 152 flow path for fluid between the inner surface of the container 102 and the outer filter 112. In some such embodiments, the roving 150 may be attached to the outer filter 112.

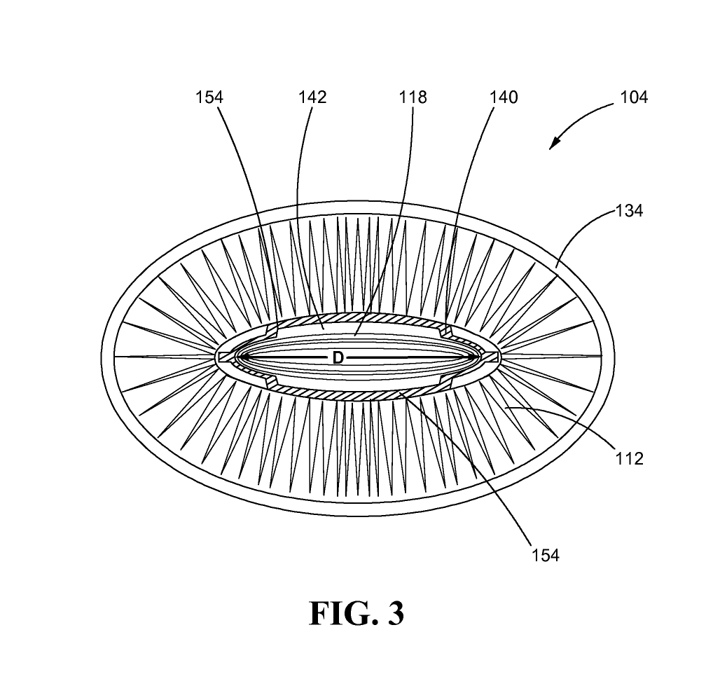

The filter element 104 may be circular, oval-shaped or other-shaped. While the filter element 104 in shown in the embodiment of FIGS. 1-2 is generally circular shaped, FIG. 3 illustrates a cross-sectional view of an alternative embodiment of the filter element 104 that is generally oval-shaped. As illustrated in FIG. 3, the outer filter 112, center tube 140, and inner filter 118 are each oval-shaped. In other embodiments, the outer filter 112 may be circular or other-shaped and the inner filter 118 and center tube 140 may be oval-shaped, circular, or other-shaped. Other shapes and combination of shapes are contemplated for the outer filter 112, inner filter 118, and center tube 140. The inventors have found that the concentric oval shapes of the inner and outer filters 118, 112 facilitates the transfer of fluid between the outer filter 112 and the inner filter 118 and minimizes the non-filtering area within the container 102.

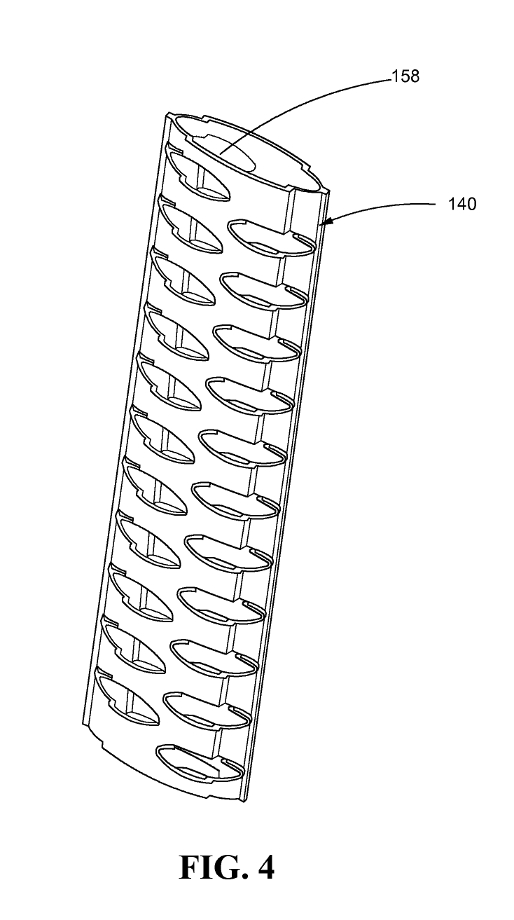

In some embodiments, the center tube 140 may, instead of being a spiral tube or spring-shaped tube, include a generally annular body that defines a plurality of apertures 158 configured to allow fluid to flow therethrough, e.g, from the outer filter 112 to the inner filter 118. FIGS. 3-4, illustrate such embodiment. In the embodiment of FIGS. 3-4, the center tube 140 perimeter is generally oval-shaped. On opposing sides across the diameter D of the center tube 140, the center tube 140 is contoured to include projections 154. In one embodiment, the projections 154 may be generally rectangular in shape and may extend the length of the center tube 140 and more than about the half the diameter of the center tube 140. Such projections 154 create one or more gaps 142 between the inner filter 118 and the outer filter 112. The center tube 140 may be made from any suitable material, such as, for example, a polymer or other plastic, and may be injection molded. It is further contemplated that apertures 158 may include any shape, size, and/or quantity.

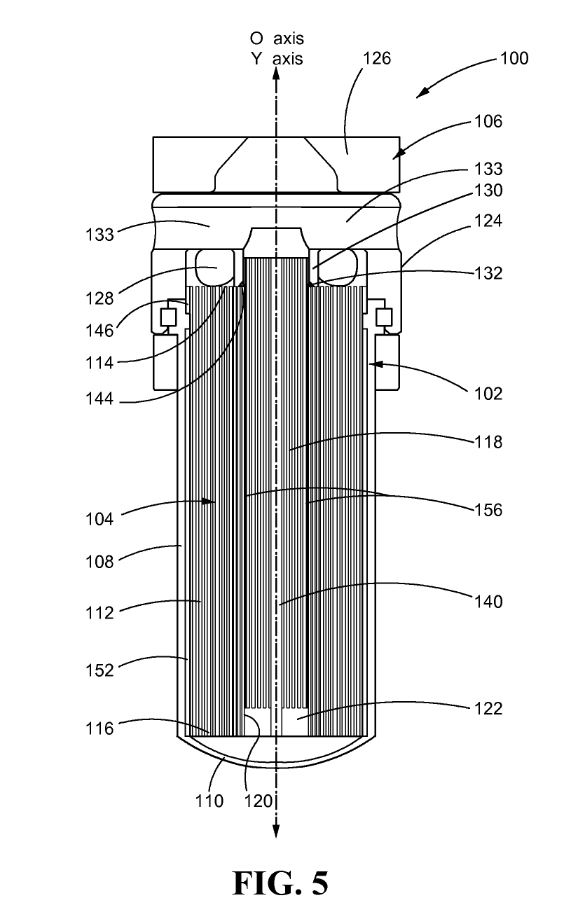

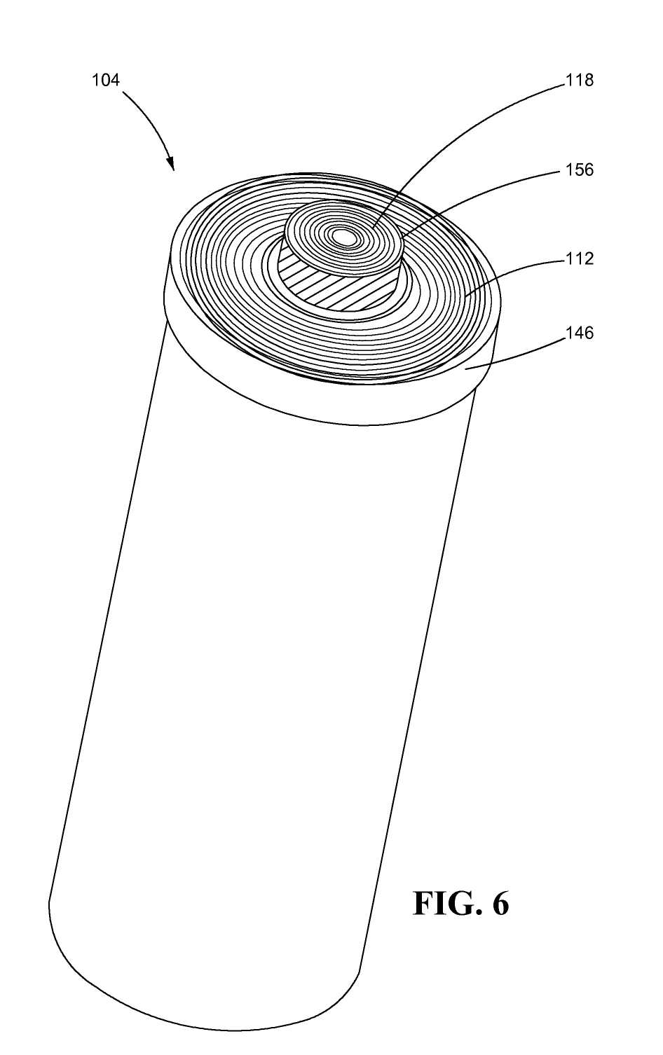

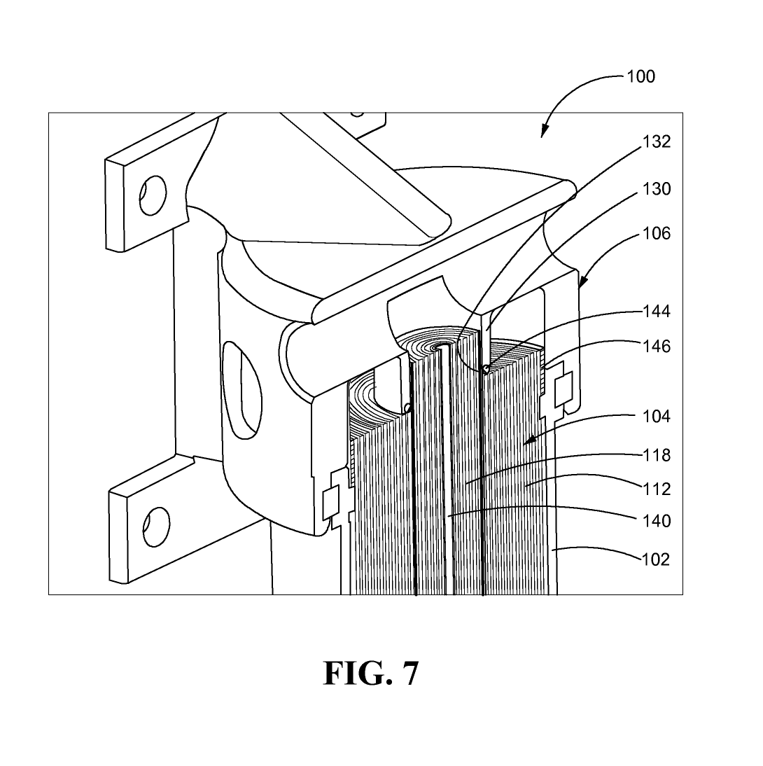

FIG. 5 illustrates a cross-section of another embodiment of the filter assembly 100. As can be seen in FIG. 5, the filter assembly includes a container 102 similar to that described with regard to FIG. 1, a filter element 104 disposed inside the container 102 and a base 106. FIG. 6 illustrates a perspective view of the filter element 104 of FIG. 5. FIG. 7 illustrates an enlarged view of a portion of the filter assembly 100 of FIG. 5.

The filter element 104 in the embodiment of FIGS. 5-6 is similar to that described above in relation to the embodiment of FIG. 1. Filter element 104 may include an outer filter 112 having a top 114 and a bottom 116, and an inner filter 118. The outer filter 112 is configured to filter to trap particulates and/or other particles suspended within a fluid and to guide received fluid from the inlet 128 to the cavity 122 in a travel path that extends in a generally downward direction generally parallel to the longitudinal axis Y, O.

The inner filter 118, similar to the embodiment illustrated in FIG. 1, is configured to trap particulates and/or other particles suspended within a fluid and to guide the fluid, in an upward direction generally parallel to the longitudinal axis Y, O, to the outlet 132 of the nozzle 130. In one embodiment, the outer and inner filters are both rolled media, for example, rolled corrugated media.

Unlike the embodiment of the filter element in FIGS. 1-3, the filter element 104 in the embodiment of FIGS. 5-6 includes a first layer 156 (instead of a center tube 140) disposed between the inner filter 118 and the outer filter 112. In an embodiment, the first layer 156 may extend substantially the full longitudinal length of the inner filter 118. The first layer 156 is impervious to fluid. For example, the first layer 156 does not allow liquid fluid to pass through it. In an embodiment, the first layer 156 may be a coating, a plastic sheet, or the like. The coating may be disposed on the inner filter 118.

The filter element 104 of FIG. 5 may not include top and bottom end caps 134, 136, or roving 150. In an embodiment, the filter element 104 of FIGS. 5-6 may include a center tube 140 that is different than that of the embodiment illustrated in FIG. 1. The center tube 140 in the embodiment illustrated in FIG. 5 may be a vented center tube. The inner filter 118 may radially surround the center tube 140 instead of being disposed inside of it.

The base 106 in the embodiment of FIG. 5 is similar to that described above in relation to the embodiment of FIG. 1, except for as described below. In some embodiments, the nozzle 130 may be generally annular shaped. The inner filter 118 (and part of the first layer) may be disposed partially inside the nozzle 130 and outlet 132 and may be stepped above the outer filter 112.

As best seen in FIG. 7, the filter element 104 of FIGS. 5-7 may also include an inner seal 144, and an outer seal 146. In some embodiments, when the filter element is positioned inside the container 102, the inner seal 144 may be disposed between the outer filter 112 and the nozzle 130, proximal to the outlet 132. The inner seal 144 may be configured to establish a radially facing seal interface with the outer surface of the inner filter 118. In one embodiment, the inner seal may be, for example, an o-ring seal. In the embodiment illustrated in FIG. 5, there is not a ring 148. In some embodiments, an outer seal may be disposed between the outer filter 112 and the base 106, and between the outer filter 112 and the container 102. In one embodiment, the outer seal 146 may be, for example, a lathe cut seal.

### INDUSTRIAL APPLICABILITY

The disclosed fluid filter assembly may be applicable to filter any type of fluid and may provide a seal between a flow of unfiltered fluid and a flow of filtered fluid without requiring numerous, complex shaped components and/or components requiring high manufacturing tolerances. The operation of fluid filter assembly 100 is explained below.

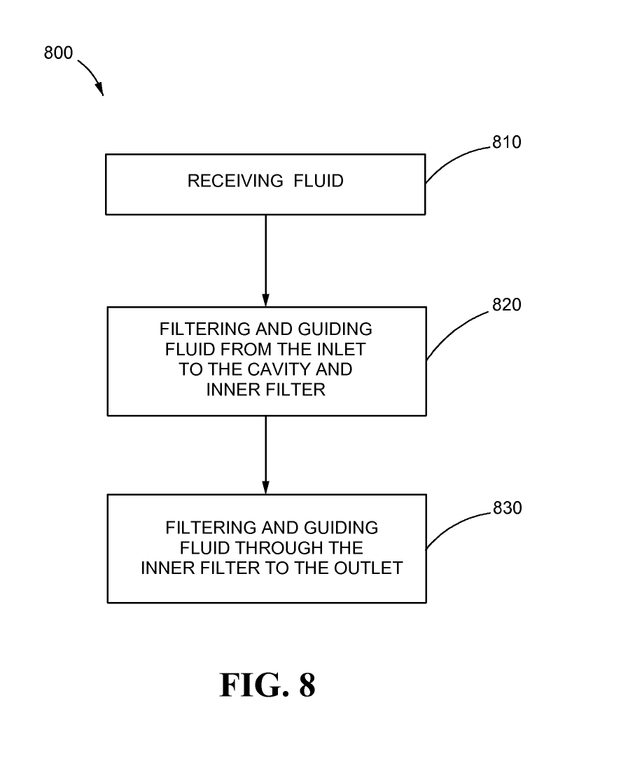

Referring to FIG. 8, an exemplary flowchart is illustrated showing sample steps of a process 800 which may be followed to filter fluid. The process will first be explained for the embodiment shown in FIG. 1. In block 810, the fluid filter assembly 100 may receive fluid to be filtered in inlet 128 from one or more upstream components of a fluid system. The “unfiltered” fluid may flow from the inlet 128 in the base 106 toward the top 114 of the outer filter 112.

In block 820, fluid is filtered guided from the inlet 128 downward away from the inlet 128 through the outer filter 112 into the cavity 122 and the inner filter 118. More specifically, fluid may flow in a number of different ways. Fluid may flow downward into the channel 152 between container 102 and outer filter 112 and then through the outer filter 112 to the gap 142, cavity 122 or to the inner filter 118. Fluid flowing in the channel 152 or gap 142 may flow in a direction generally parallel to the longitudinal axis Y, O. Depending on the fluid level and suction/pressure forces present in the filter assembly 100 from a pump or other suction source (not shown) operably connected to the filter assembly 100, in some embodiments, the fluid in the channel 152 or gap 142 may flow in a generally horizontal direction toward the inner filter 118. In the embodiment illustrated in FIG. 1, the fluid flowing in the outer filter 112 may flow in a generally radial direction through outer filter 112.

Fluid may also flow directly into the outer filter 112 and then to the gap 142 between the outer filter 112 and the inner filter 118, the inner filter 118, or to the cavity 122. The outer filter 112 may trap particles suspended within the fluid to thereby filter the fluid. The fluid filtered by the outer filter 112 may then flow into the cavity 122 or through the center tube 140 (either between the coils or through the apertures 158).

In block 830, fluid received by the inner filter 118 from the cavity 122 and from the gap 142 is filtered and guided upward through the inner filter 118 to the outlet 132 of the nozzle 130. The fluid in the inner filter 118 travels in a direction generally parallel to the longitudinal axis Y, O and in a different direction than the fluid moving through the outer filter 112, gap 142 or channel 152. Inner filter 118 may trap particles suspended within the fluid to thereby further filter the fluid. The fluid may be drawn upward through the inner filter 118 by a suction source (not shown) or the like. The filtered fluid may further flow through the outlet port 26 into the nozzle 130 and out the outbound artery 133 toward one or more downstream components of the fluid system.

The process 800 will now be explained for the embodiment shown in FIG. 5. Step 810 is unchanged. In block 820, fluid is filtered and guided from the inlet 128 downward away from the inlet 128 through the outer filter 112 into the cavity 122. More specifically, fluid may flow in a number of different ways. Fluid may flow downward into the channel 152, if there is one, between container 102 and outer filter 112 and then through the outer filter 112 to the cavity 122. Fluid flowing in the channel 152 may flow in a direction generally parallel to the longitudinal axis Y, O. Depending on the fluid level and suction forces present in the filter assembly 100 from a pump or other suction source (not shown) operably connected to the filter assembly 100, in some embodiments, the fluid in the channel 152 may flow in a generally horizontal direction toward the outer filter 112.

Fluid may also flow directly into the outer filter 112 and then to the cavity 122. The outer filter 112 traps particles suspended within the fluid to thereby filter the fluid. The fluid filtered by the outer filter 112 may then flow into the cavity 122. In the embodiment illustrated in FIG. 5, the fluid flowing in the outer filter 112 may flow in a travel path generally parallel to the longitudinal axis Y, O. Fluid does not enter the inner filter 118 from the outer filter because of the layer 156.

In block 830, fluid received by the inner filter 118 from the cavity 122 is filtered and guided upward through the inner filter 118 to the outlet 132 of the nozzle 130. The fluid in the inner filter 118 travels in a direction generally parallel to the longitudinal axis Y, O and in a different direction than the fluid moving through the outer filter 112 or channel 152. Inner filter 118 may trap particles suspended within the fluid to thereby further filter the fluid. The fluid may be drawn upward through the inner filter 118 by a suction source (not shown) or the like. The filtered fluid may further flow through the outlet port 26 into the nozzle 130 and out the outbound artery 133 toward one or more downstream components of the fluid system.

It will be apparent to those skilled in the art that various modifications and variations can be made to the disclosed fluid filter system. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A filter element comprising:
an outer filter having a top and a bottom, the outer filter defining an interior space and a longitudinal axis, the interior space extending from the top to the bottom of the outer filter along the longitudinal axis; and
an inner filter disposed inside the interior space, the inner filter offset along the longitudinal axis from the bottom of the outer filter, the offset defining a cavity disposed below the inner filter and adjacent to the bottom of the outer filter,
wherein the outer filter is configured to filter and guide fluid in a first direction and the inner filter is configured to filter and guide fluid in a second direction generally parallel to the longitudinal axis, the second direction different from the first direction.

2. The filter element of claim 1, wherein the inner filter is rolled.

3. The filter element of claim 1, wherein the inner filter is corrugated media and the outer filter is cellulose media.

4. The filter element of claim 1, wherein the inner and outer filters are generally oval-shaped.

5. The filter element of claim 1, further comprising:
a center tube disposed between the inner filter and the outer filter, the center tube shaped and positioned to define a gap between the inner filter and the outer filter; and
a ring disposed inside the center tube and above the inner filter.

6. The filter element of claim 1, wherein the outer filter is configured to filter and guide received fluid in a travel path generally parallel to the longitudinal axis.

7. The filter element of claim 1, further comprising a first layer disposed between the inner filter and the outer filter, the first layer extending substantially the full longitudinal length of the inner filter, wherein the first layer is impervious to fluid.

8. A filter assembly comprising:
a container defining a longitudinal axis, the container configured to be received by a base;
a removeable filter element including:
an outer filter disposed inside the container, the outer filter having a top and a bottom, the outer filter defining an interior space extending from the top to the bottom of the outer filter; and
an inner filter disposed inside the interior space, the inner filter offset along the longitudinal axis from the bottom of the outer filter, the offset defining a cavity disposed below the inner filter and adjacent to the bottom of the outer filter; and
the base adjacent to the top of the outer filter, the base including an inlet and a nozzle having an outlet, the inlet fluidly connected to the top of the outer filter, and the outlet fluidly connected to the inner filter,
wherein the filter assembly is configured to filter and guide liquid in a generally downward direction from the inlet to the cavity and the inner filter is configured to filter and guide liquid, in an upward direction generally parallel to the longitudinal axis, to the outlet of the nozzle.

9. The filter assembly of claim 8, wherein the inner filter is rolled corrugated media and the outer filter is cellulose media.

10. The filter assembly of claim 9, wherein the inner filter is generally oval-shaped, and the outer filter is generally oval-shaped cellulose media.

11. The filter assembly of claim 8, in which the filter element further includes:
a center tube disposed between the inner filter and the outer filter, the center tube shaped and positioned to define a gap between the outer filter and the inner filter; and
a first seal disposed inside the center tube and between the outer filter and the nozzle, the first seal configured to establish a radially facing seal interface with the nozzle.

12. The filter assembly of claim 11, in which the filter element further includes an inner ring disposed inside the center tube, above the inner filter, and below the first seal.

13. The filter assembly of claim 12, wherein the center tube is a spiral center tube.

14. The filter assembly of claim 8, in which the filter element further includes:
a first seal disposed between the outer filter and the nozzle, the first seal configured to establish a radially facing seal interface with the inner filter; and
a second seal disposed between the outer filter and the base and between the outer filter and the container.

15. The filter assembly of claim 8, in which the filter element further includes spiral roving disposed around the outer filter between the outer filter and the container, wherein the outer filter is made of cellulose media.

16. The filter assembly of claim 8, wherein the inner and outer filters are made of rolled corrugated media, wherein further the outer filter is configured to filter and guide received fluid in a generally downward travel path generally parallel to the longitudinal axis.

17. The filter assembly of claim 16, further including a vented center tube generally parallel to the longitudinal axis, the inner filter surrounding the vented center tube.

18. The filter assembly of claim 8, in which the filter element further includes a first layer disposed between the inner filter and the outer filter, wherein the inner filter is rolled and the first layer is impervious to liquid fluid.

19. The filter element of claim 8, further comprising a first radial seal disposed around the inner filter and above the top of the outer filter, wherein the inner filter is disposed partially in the outlet port and is stepped above the top of the outer filter.

20. A method of filtering liquid fluid in a vehicle system with a filter assembly, the filter assembly comprising a container, a filter element and a base, the container defining a longitudinal axis, the container configured to be received by the base, the filter element including an outer filter disposed inside the container, the outer filter having a top and a bottom, the outer filter defining an interior space extending from the top to the bottom of the outer filter and an inner filter disposed inside the interior space, the inner filter offset along the longitudinal axis from the bottom of the outer filter, the offset defining a cavity disposed below the inner filter and adjacent to the bottom of the outer filter, the base adjacent to the top of the outer filter, the base including an inlet and a nozzle having an outlet, the inlet fluidly connected to the top of the outer filter, and the outlet fluidly connected to the inner filter, the method comprising:
receiving fluid from an inlet in the base;
filtering fluid as it flows in a first direction from the inlet port through the outer filter into the cavity; and
filtering fluid from the cavity as it flows second direction to the outlet port of the nozzle through the inner filter from the cavity, the second direction different from the first direction, the second direction generally parallel to the longitudinal axis.
